(19) United States
(12) Patent Application Publication
(10) Pub. No.: US 2015/0314947 A1
(43) Pub. Date: Nov. 5, 2015

(54) Removable Plastic Components that Separate and Organize Merchandise Protection Supplies

(71) Applicants: DANIEL ANDREW MACKIE, SAN FRANCISCO, CA (US); SCOTT GLEN BOTN, SAN RAFAEL, CA (US)

(72) Inventors: DANIEL ANDREW MACKIE, SAN FRANCISCO, CA (US); SCOTT GLEN BOTN, SAN RAFAEL, CA (US)

(21) Appl. No.: 14/450,234

(22) Filed: Aug. 2, 2014

Related U.S. Application Data
(60) Provisional application No. 61/986,459, filed on Apr. 30, 2014.

(51) Int. Cl. B65D 85/00; G09F 3/02

(52) U.S. Cl. CPC B65D 85/00; G09F 3/02; G09F 2003/0216

(57) ABSTRACT

The invention provides removable plastic components that separate and organize merchandise protection supplies at register consoles in retail environments. The removable plastic components separate and organize the various merchandise protection devices and components utilized in any given retail establishment by providing interchangeable receptacles that can be filled at register consoles as security devices are removed from merchandise and then sealed and removed from the console for storage or transportation of the enclosed security components.

### CROSS-REFERENCE TO RELATED APPLICATIONS

This application claims the benefit of U.S. Provisional Application for Patent Ser. No. 61/986,459, filed on Apr. 30, 2014, entitled “REMOVABLE PLASTIC COMPONENTS THAT SEPARATE AND ORGANIZE MERCHANDISE PROTECTION SUPPLIES,” the disclosure of which is hereby incorporated by reference.

### FEDERALLY-SPONSORED RESEARCH

Not Applicable.

### SEQUENCING LISTING

Not applicable.

### BACKGROUND AND SUMMARY OF THE INVENTION

Retail establishments, such as department stores, often use merchandise security devices to prevent theft. When a customer purchases merchandise, a store clerk removes the security device and usually places all components into a common receptacle, such as a cardboard box, near the register console. Merchandise protection devices at registers can, thus, be very messy and unorganized, resulting in maximum time and labor required to later organize and separate the security device components. Until now, there existed an unmet need for a better register console organization system.

The new merchandise security device organizer offers an efficient and effective means for separating and organizing merchandise protection supplies. In use, the removable tube components are used to separate and organize various manufactured merchandise protection supplies. When full, a removable tube component can be removed and emptied or removed for storage and replaced by another tube component.

In general, the removable tube components are slotted onto a mounting plate, which can be mounted to any vertical surface, such as the wall of a register console or in a store's receiving area. Each removable tube component has a lid to secure merchandise protection devices within. Since merchandise protection devices vary in their attachment means, a removable tube component may have a pin chamber attached thereto. Hard tags and ink tags, for example, each contain two components.

The sum of these advantages unifies with the novel device for sorting and storing merchandise security devices, resulting in an invention that is not anticipated, rendered obvious, suggested, or even implied by any of the prior art support, either alone or in any combination thereof.

These, together with other objects of the invention, along with the various features of novelty characterizing the invention, are described with particularity in the claims herewith. A more comprehensive understanding of the features, operation and uses of the invention may be gleaned from reference to the enclosed drawings and descriptive matter further illustrating the preferred embodiments of the invention.

The embodiments described herein are illustrative of the invention, and it is to be understood that the invention is not limited in its application to the details of construction and to the arrangements of the components set forth in the following description and drawings. The invention is capable of other embodiments and of being practiced and carried out in various ways. It should be further understood that the phraseology and terminology applied herein merely serve the purpose of description and should not be regarded as limiting.

### BRIEF DESCRIPTION OF THE DRAWINGS

FIGS. 1A and 1B depict the top view of one embodiment of the merchandise protection device organizer showing the tube system and the mounting plate apart from each other (not in use) and attached (in use), respectively.

FIG. 2 illustrates the perspective view of one embodiment of the merchandise protection device organizer, showing the tube system as detached from the mounting plate.

FIG. 3 depicts the top view of another embodiment of the merchandise protection device organizer showing the tube system and the mounting plate set apart from each other.

FIG. 4A and 4B depict the side view of one embodiment of the merchandise protection device organizer showing the tube system and the mounting plate attached with the lid on and off, respectively.

### DETAILED DESCRIPTION OF THE INVENTION

In accordance with this invention, it is now possible for merchandise protection devices to be sorted quickly at the register and stored according to their unique size and function. This replaces the former method of storing all devices in one box, which eliminates the need for sorting and, thus, maximizes employee efficiency with respect to attachment and removal of merchandise protection devices.

The following example is submitted to illustrate but not to limit this invention.

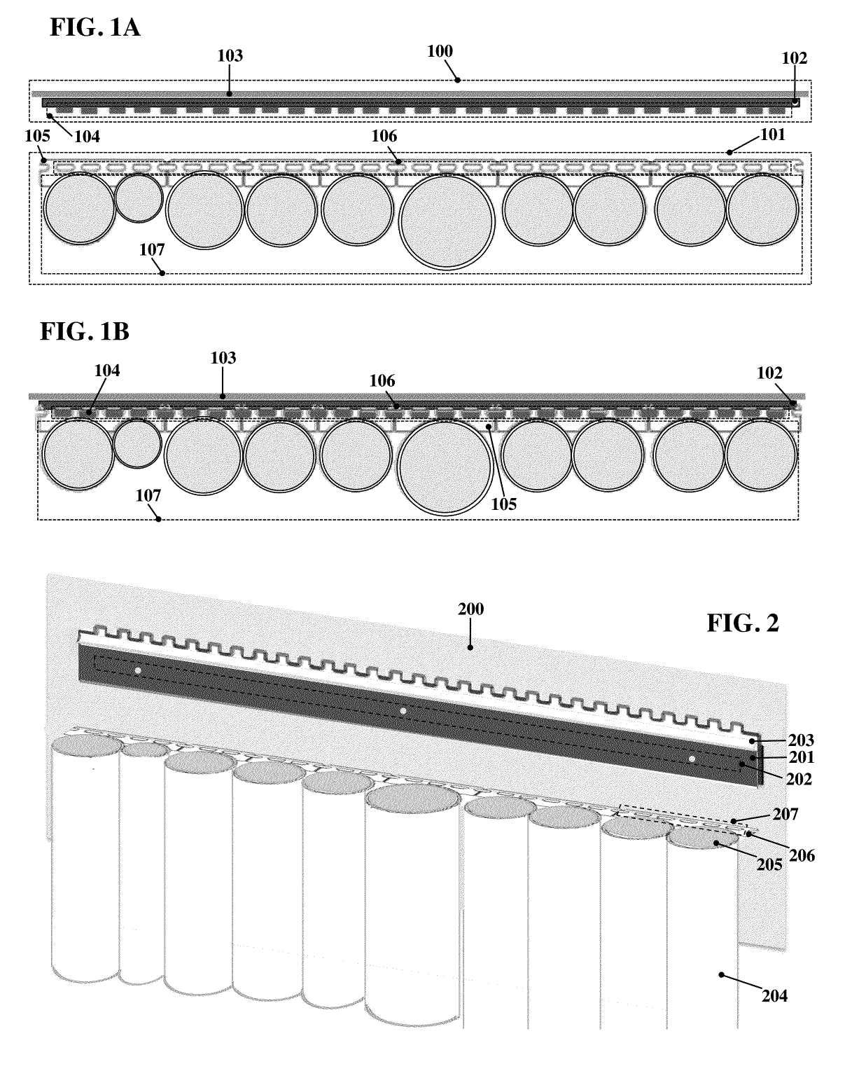

FIGS. 1A and 1B collectively depict the top view of one embodiment of the merchandise protection device organizer showing the tube system and the mounting plate apart from each other (not in use) and attached (in use), respectively. FIG. 1A shows distinctly the two primary components of the new merchandise security device organizer: the wall mount component 100 and the removable tube component 101. The wall mount component 100 consists of a mounting plate 102, which is attached to a vertical surface 103 on its backside and has slats 104 attached to the front side. The removable tube component 101 consists of a tube support 105 containing vertical slat slots 106 and tubes 107 attached generally perpendicularly thereto. FIG. 1B shows the new merchandise security device organizer components in their in-use positions. The mounting plate 102 is attached securely to the vertical surface 103. The tube support 105 connects the tubes 107 to the wall mount component (as shown in FIG. 1A) by nesting its slat slots 106 over the slats 104 and resting on the mounting plate 102.

FIG. 2 illustrates the perspective view of one embodiment of the merchandise protection device organizer, showing the tube system as detached from the mounting component. The mounting plate 201 is attached to a vertical surface 200, such as a register console or in a store's receiving area, by three nails 202. The means for mounting the mounting plate 201 can vary and should be selected to suit the use and location of the new merchandise security device organizer. For example, mounting can be accomplished by strong double-sided tape where it is undesirable to hammer nails into the vertical attachment surface. Attached to the front of the mounting plate 201 are slats 203. Further shown is a series of tubes 204, each of which has a lid 205 and is attached to a tube support 206. Each tube support 206 has a series of slat slots 207. In use, the tube support 206 connects the tube 204 to the mounting plate 201 by nesting the slat slots 207 over the slats 203.

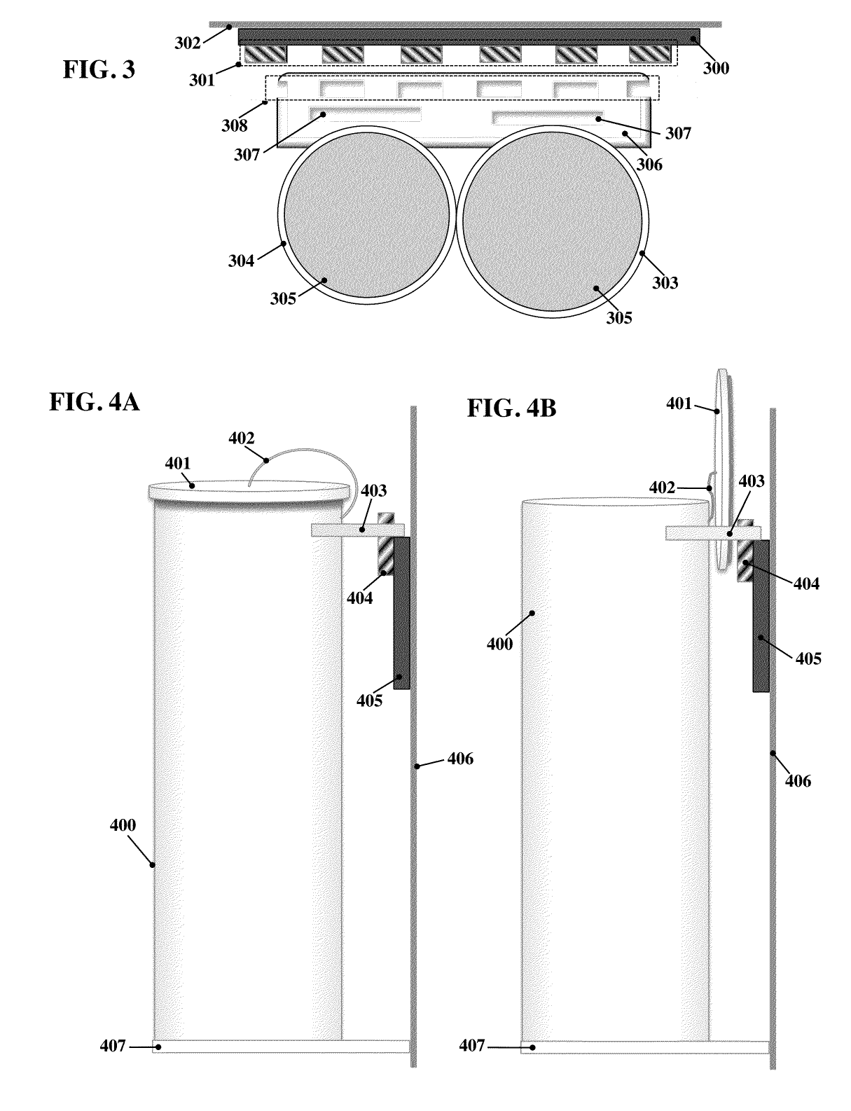

FIG. 3 depicts the top view of another embodiment of the merchandise protection device organizer showing the tube system and the mounting plate set apart from each other. Here, the mounting plate 300 has slats 301 attached to its front side and a means for attaching to a vertical surface 302 on its bask side. The removable tube component is comprised of a regular tube 303 for sorting and storing the main component of two-piece security devices and a pin chamber 304 for sorting and storing the pin component of the security device. The regular tube 303 and the pin chamber 304 each bear a lid 305 for securing the security device components within and are both connected to a common tube support 306, which contains lid storage slots 307 and slat slots 308. The lid storage slots 307 enable the lids 305 to rest vertically between the tubes and the mounting components when in use. The slat slots 308 enable the tube support 306 to fit over the slats 301 and rest on the mounting plate 300 when in use.

FIGS. 4A and 4B collectively depict the side view of one embodiment of the merchandise protection device organizer showing the tube system and the mounting plate attached with the lid on and off, respectively. FIG. 4A shows the main body 400 of the removable tube component having a lid 401 in place on the top of the tube body, the lid being further attached to the tube body by a cord 402, which connects to the backside of the tube body at one end and to the center of the lid at the other end. The lid 401 may be secured to the tube body 400 by any standard connection means, such as snap- or screw-on. The tube body 400 is fitted with a generally planar tube support 403, which is attached perpendicularly to the tube body and contains rectangular slots (not shown). The tube support 403 positions and secures the tube body 400 to a vertical surface by fitting over vertical slats 404 attached to a mounting plate 404, which attaches to the desired surface 406, such as a cash register console or in a store's receiving area. In use, the slats 404 align with and fit into the slots of the tube support 403, enabling the body of the tube support to rest on top of the mounting plate 405. The tube body 400 is maintained in a generally vertical position with the assistance of the tube base 407, which serves to seal the bottom of the tube body and spans the distance from the front of the tube body to the vertical surface 406, providing horizontal support the tube's base.

FIG. 4B depicts the side view described in FIG. 4A but with the lid in the open position. Here, the lid 401 is removed from the top of the tube body 400 and set vertically into a lid slot (not shown) in the tube support 403. This feature conveniently keeps the lid from dangling to the side of the tube and from potentially getting tangled with the cords of other lids. The lid 401 is further secured to the tube body 400 by a cord 402, which ensures the lid is not separated (lost) from the removable tube component.

As to further discussion of the manner of usage and operation of the present invention, the same should be apparent from the above description. With respect to the above description then, it is to be realized that the optimum components of this invention, to include variations in technological enablement, size, dimensional relationships, and composition, are deemed readily apparent and obvious to one skilled in the art, and all equivalent relationships to those illustrated in the drawings and described in the specification are intended to be encompassed by the present invention, the use of which results in a method for conveniently sorting and storing merchandise security devices.

Although the description presented heretofore contains specificities for the benefit of illustration, these should not be construed as limiting the scope of the embodiments but rather as illustrative examples of some of the several embodiments. Thus, the scope of the embodiments should be determined by the appended claims and their legal equivalents rather than by the examples provided.

1. A merchandise protection device organizer comprising:
a mounting plate having a front side and a back side and a top;
a substantially vertical surface, such as a wall;
an attachment means for attaching the back side of the mounting plate to the vertical surface, such as hardware or an adhesive strip;
one or more slats attached to the front side of the mounting plate and arranged generally horizontally, said slats extending above the top of the mounting plate;
one or more removable hollow member(s) of a generally cylindrical shape having a lower end and an open upper end and a front and a back;
one or more base(s) in a quantity equal to that of the hollow member(s), each said base being substantially centrally mounted on the lower end of a hollow member as to seal the hollow member and extending in length beyond the back of the hollow member to said vertical surface;
one or more removable lid(s) in a quantity equal to that of the hollow member(s), said lid(s) having diameter(s) roughly equal to that or those of the hollow member(s) such that each lid has a corresponding hollow member, said lid(s) further having attachment means for securing each lid to the corresponding hollow member;
a tethering means, such as a cord, in a quantity equal to that of the hollow member(s), each said tethering means being attached to both the hollow member and the corresponding lid;
one or more tube support(s) in a quantity equal to that of the hollow member(s), each said tube support being attached perpendicularly to the back side of a hollow member; and
one or more slat slot(s), each extending perpendicularly though a tube support, each slat slot having slightly larger dimensions than those of said slats such that the slats can be nested into the slat slot(s) of the tube support(s).

2. The merchandise protection device organizer of claim 1 further comprising a lid slot in each tube support, said slot extending perpendicularly through the tube support and being of a width slightly wider than the thickness of the lid and being of a length shorter than the diameter of the lid.

3. The merchandise protection device organizer of claim 1 further comprising a marked or altered section of outer surface of each hollow member suitable for labeling the tube as to render its contents or intended contents readily ascertainable.
